(19) United States
(12) Patent Application Publication
(10) Pub. No.: US 2026/0307666 A1
(43) Pub. Date: Oct. 8, 2026

(54) RISK EVALUATION APPARATUS, RISK EVALUATION METHOD, AND RISK EVALUATION SYSTEM

(71) Applicant: BRIDGESTONE CORPORATION, Tokyo (JP)

(72) Inventor: Kodai SATO, Chuo-ku, Tokyo (JP)

(73) Assignee: BRIDGESTONE CORPORATION, Tokyo (JP)

(21) Appl. No.: 19/482,098

(22) PCT Filed: Nov. 30, 2023
(86) PCT No.: PCT/JP2023/042969

§ 371 Date: Nov. 6, 2025

(30) Foreign Application Priority Data
May 30, 2023 (JP) 2023-089010

(51) Int. Cl. B60W 50/02; B60W 50/029

(52) U.S. Cl. CPC B60W 50/0205; B60W 50/029; B60W 2050/021; B60W 2520/105; B60W 2530/20; B60W 2556/10; B60W 2556/40; B60W 2556/50

(57) ABSTRACT

A risk evaluation apparatus includes a storage and a controller. The storage stores first travel data for a plurality of first tires in which a predetermined failure occurred, the first travel data accumulating information on position and acceleration when a vehicle, on which each of the first tires was mounted, traveled a travel route in the past, and second travel data for a plurality of second tires in which the predetermined failure has not occurred, the second travel data accumulating information on position and acceleration when a vehicle, on which each of the second tires was mounted, traveled the travel route in the past. The controller evaluates a risk of tire failure occurrence on the travel route based on a difference between the acceleration included in the first travel data and the acceleration included in the second travel data.

### TECHNICAL FIELD The present disclosure relates to a risk evaluation apparatus, a risk evaluation method, and a risk evaluation system.

### BACKGROUND

Toward the realization of a sustainable society, it is required to increase resource productivity by using resources such as tires for as long as possible. From this perspective, it is desirable to suppress failures that occur before a tire is completely worn out as much as possible. As a technology for suppressing tire failures, a quantitative analysis method for tire failure causes has been proposed, which can quantitatively analyze whether the cause of a tire failure lies in the tire itself or in the severity of the tire usage conditions (see, for example, PTL 1). This quantitative analysis method takes into account not only the forces acting on the tire mounted on a running vehicle, but also the severity of tire usage conditions such as vehicle running speed, elevation differences of the running road surface, curves, and gradient information.

### CITATION LIST

### Patent Literature

PTL 1: JP 2006-84222 A

### SUMMARY

### Technical Problem

However, in the method disclosed in the prior art literature, although a method for analyzing the cause of failure is disclosed, a specific method for suppressing failures is not presented, making it difficult to apply in practice. In addition, in the method disclosed in the prior art literature, too many causes of failure are presented, making it difficult to determine which points should be focused on for countermeasures. That is, there was room for improvement in systems for evaluating the causes of tire failures.

Therefore, an object of the present disclosure, which has been made in view of these points, is to provide a risk evaluation apparatus, a risk evaluation method, and a risk evaluation system capable of evaluating the risk of tire failure occurrence on a travel route by a simple method.

### Solution to Problem

(1) A risk evaluation apparatus according to one aspect of the present disclosure includes a storage configured to store first travel data for a plurality of first tires in which a predetermined failure occurred, the first travel data accumulating information on position and acceleration when a vehicle, on which each of the first tires was mounted, traveled a travel route in the past, and second travel data for a plurality of second tires in which the predetermined failure has not occurred, the second travel data accumulating information on position and acceleration when a vehicle, on which each of the second tires was mounted, traveled the travel route in the past; and a controller configured to evaluate a risk of tire failure occurrence on the travel route based on a difference between the acceleration included in the first travel data and the acceleration included in the second travel data.
(2) A risk evaluation apparatus according to an embodiment of the present disclosure is the risk evaluation apparatus described in (1) above, wherein the controller quantifies the difference between the acceleration in the first travel data and the acceleration in the second travel data, and can identify, from the travel route, positions at which the quantified difference in acceleration is relatively large as risk locations.
(3) A risk evaluation apparatus according to an embodiment of the present disclosure is the risk evaluation apparatus described in (2) above, wherein the controller can rank the risk locations based on a magnitude of the difference in the acceleration.
(4) A risk evaluation apparatus according to an embodiment of the present disclosure is the risk evaluation apparatus described in (3) above, wherein the controller can extract only a predetermined number of the risk locations in order from a largest difference in the acceleration among the risk locations subjected to ranking.
(5) A risk evaluation apparatus according to an embodiment of the present disclosure is the risk evaluation apparatus described in any one of (2) to (4) above, wherein the controller can identify the risk locations on the travel route based on map information of the travel route.
(6) A risk evaluation apparatus according to an embodiment of the present disclosure is the risk evaluation apparatus described in any one of (2) to (5) above, wherein the controller can generate, select, or determine one or more measures for suppressing the predetermined failure at the risk locations based on the difference in the acceleration.
(7) A risk evaluation apparatus according to an embodiment of the present disclosure is the risk evaluation apparatus described in any one of (1) to (6) above, wherein the first tires and the second tires may be at least any of tires of a port vehicle, a bus or truck that repeatedly travels a specific route, and a mine vehicle.
(8) A risk evaluation apparatus according to an embodiment of the present disclosure is the risk evaluation apparatus described in any one of (1) to (7) above, wherein the acceleration may include three-dimensional directional components.
(9) A risk evaluation method according to one aspect of the present disclosure is a risk evaluation method executed by a computer, comprising acquiring first travel data for a plurality of first tires in which a predetermined failure occurred, the first travel data accumulating information on position and acceleration when a vehicle, on which each of the first tires was mounted, traveled a travel route in the past, and second travel data for a plurality of second tires in which the predetermined failure has not occurred, the second travel data accumulating information on position and acceleration when a vehicle, on which each of the second tires was mounted, traveled the travel route in the past; and evaluating a risk of tire failure occurrence on the travel route based on a difference between the acceleration included in the first travel data and the acceleration included in the second travel data.
(10) A risk evaluation system according to one aspect of the present disclosure includes a vehicle having a position detector configured to detect position, an accelerometer configured to detect acceleration, and a vehicle communication interface configured to transmit information on the position and the acceleration to the risk evaluation apparatus; the risk evaluation apparatus according to any one of (1) to (8) above; and a terminal device configured to report a notification transmitted from the risk evaluation apparatus, wherein the controller of the risk evaluation apparatus generates the notification based on the evaluation of the risk of failure occurrence and transmits the notification to the terminal device for reporting.
(11) A risk evaluation system according to an embodiment of the present disclosure is the risk evaluation system described in (10) above, wherein the risk evaluation apparatus includes an acquisition interface configured to acquire, as third travel data, information on position and acceleration when the vehicle has traveled the travel route, and the controller can generate the notification based on similarity between the third travel data and the first travel data and transmit the notification to the terminal device.
(12) A risk evaluation system according to an embodiment of the present disclosure is the risk evaluation system described in (10) above, wherein the risk evaluation apparatus includes an acquisition unit configured to acquire, as third travel data, information on position and acceleration when the vehicle has traveled the travel route, and the controller can generate a notification including a method for increasing similarity between the third travel data and the second travel data and transmit the notification to the terminal device.
(13) A risk evaluation system according to an embodiment of the present disclosure is the risk evaluation system described in any one of (10) to (12) above, wherein the storage accumulates the information on the position and the acceleration acquired from the vehicle, and the controller updates the first travel data or the second travel data using the accumulated information on the position and the acceleration.
(14) A risk evaluation system according to an embodiment of the present disclosure is the risk evaluation system described in any one of (10) to (13) above, wherein the terminal device includes at least one of a display, a speaker, a light emitter, and a vibrator, and reports the notification by at least one of text, sound, light, and vibration.

### Advantageous Effect

According to the present disclosure, it is possible to evaluate the risk of tire failure occurrence on a travel route by a simple method using the position and acceleration of a vehicle.

### BRIEF DESCRIPTION OF THE DRAWINGS

In the accompanying drawings:

FIG. 1 is a block diagram illustrating a schematic configuration of a system including a risk evaluation apparatus according to an embodiment;

FIG. 2 is a block diagram illustrating a schematic configuration of the risk evaluation apparatus of FIG. 1;

FIG. 3 is a block diagram illustrating a schematic configuration of the terminal device of FIG. 1;

FIG. 4 is a diagram illustrating an example of a method for presenting a travel route and risk locations;

FIG. 5 is a diagram for explaining an example of a method for identifying risk locations based on changes in acceleration along a travel route;

FIG. 6 is a flowchart illustrating an example of a procedure for evaluating the risk of tire failure occurrence;

FIG. 7 is a block diagram illustrating a schematic configuration of a risk evaluation system according to an embodiment;

FIG. 8 is a block diagram illustrating a schematic configuration of the terminal device of FIG. 7; and

FIG. 9 is a block diagram illustrating a schematic configuration of the in-vehicle device of FIG. 7.

Hereinafter, embodiments of the present disclosure will be described with reference to the drawings.

### OVERALL CONFIGURATION

A risk evaluation apparatus 10 for evaluating the risk of occurrence of a failure in a tire (tire failure occurrence risk) according to one embodiment of the present disclosure is an apparatus that evaluates the risk of a predetermined failure occurring in a tire on a travel route repeatedly traveled by a vehicle. The predetermined failure includes significant failures related to the lifespan of the tire. The “predetermined failure” may include all failures related to the lifespan of the tire. The “predetermined failure” may be determined by the user of the risk evaluation apparatus 10. In the following description, the “predetermined failure” may simply be referred to as “failure.” The risk evaluation apparatus 10 acquires travel data resulting from the travel of the travel route by a large number of vehicles, together with information on whether a predetermined failure has occurred in the tire. As illustrated in FIG. 1, the risk evaluation apparatus 10 can transmit a notification generated as a result of the risk evaluation to a terminal device 20. The notification includes an alert indicating that the risk is high.

Vehicles equipped with tires that are the subject of risk evaluation by the risk evaluation apparatus 10 include large trucks, vehicles for transporting vehicles, special vehicles for construction and civil engineering, as well as vehicles used in special environments such as mines. The vehicle may be equipped with one or more tires. The number of tires may be one or more, for example, 6, 8, 10, and so on. However, the number of tires is not limited to even numbers. The vehicle includes vehicles that transport heavy loads and vehicles that repeatedly travel rough road surfaces. In one embodiment, the vehicle is a mine vehicle used in a mine that repeatedly travels a designated travel route. As another embodiment, examples include port vehicles, buses or trucks that repeatedly travel a designated travel route (specific route), and other similar vehicles. Since such vehicles involve multiple similar vehicles with similar load conditions traveling the same route, it is easy to collect data on failed tires, and the effects of the risk evaluation apparatus 10 described below are readily obtained.

Vehicles equipped with tires that are the subject of risk evaluation by the risk evaluation apparatus 10 are provided with a position sensor and an accelerometer.

The position sensor is a sensor that detects the position of the vehicle. As the position sensor, position information obtained from a GPS (Global Positioning System) receiver can be used. As the position sensor, a receiver of a global navigation satellite system (GNSS) other than GPS may be adopted. To supplement the position information obtained from GPS, the position sensor may include a direction sensor and a distance sensor. Where reception of the current position by the GPS receiver is not possible, the position sensor can detect the current position by dead reckoning using both the direction sensor and the distance sensor.

The position information acquired by the position sensor may be planar position information that considers a plane including the longitudinal and lateral directions of the vehicle, assuming the vehicle is located on a flat road surface with no gradient. In addition to this planar position information, the position information may also be three-dimensional position information that considers the vertical position, i.e., elevation.

The accelerometer measures the acceleration of the vehicle. The accelerometer measures acceleration in at least one or more directions among the lateral, longitudinal, and up-down directions of the vehicle. The accelerometer may be capable of measuring acceleration in all three axes: lateral, longitudinal, and up-down directions of the vehicle.

The accelerometer includes various types such as mechanical displacement measurement type, optical type, semiconductor type, etc., but is not limited thereto. Semiconductor-type accelerometers include various types such as piezoresistive type, capacitive type, gas temperature distribution type, etc., but are not limited thereto.

### Risk Evaluation Apparatus

The risk evaluation apparatus 10 is an information processing apparatus (computer) such as a PC (Personal Computer). The risk evaluation apparatus 10 has travel data that accumulates information on position and acceleration when multiple vehicles traveled the travel route in the past. The risk evaluation apparatus 10 evaluates the risk of tire failure occurrence on the travel route based on this travel data. The risk evaluation apparatus 10 may receive travel data edited by another device from that other device.

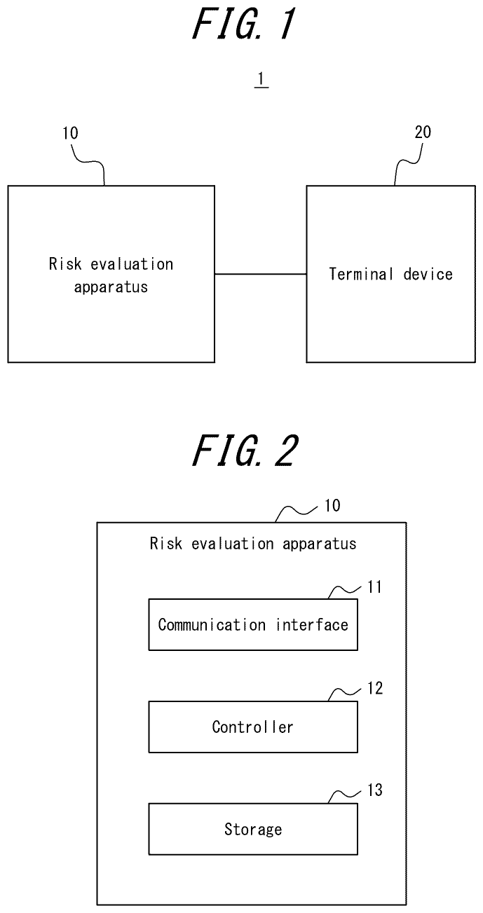

As illustrated in FIG. 2, the risk evaluation apparatus 10 includes a communication interface 11, a controller 12, and a storage 13.

The communication interface 11 has a communication function for communicating with external devices of the risk evaluation apparatus 10. The communication interface 11 includes a communication module that connects to a communication network such as the Internet via wired or wireless communication. The communication interface 11 may include a communication module compatible with mobile communication standards such as 4G (4^{th} Generation), 5G (5^{th} Generation), etc. The communication interface 11 may include a communication module compatible with wired LAN standards (for example, 1000BASE-T). The communication interface 11 may include a communication module compatible with wireless LAN standards (for example, IEEE802.11).

The risk evaluation apparatus 10 can acquire past travel data of vehicles from external devices via the communication interface 11. The past travel data of vehicles includes first travel data and second travel data.

The first travel data is data that accumulates information on position and acceleration obtained when vehicles equipped with each of a plurality of tires in which a predetermined failure occurred traveled the travel route in the past. Hereinafter, a tire in which a predetermined failure occurred is referred to as a first tire. A tire in which a predetermined failure occurred is a tire in which a predetermined failure occurred during use before the original lifespan of the tire. In tires mounted on vehicles that transport heavy loads and vehicles that repeatedly travel rough road surfaces, a predetermined failure may occur during use due to inadequate management and use under harsh environments. The information on position and acceleration is data acquired in large quantities, either periodically or non-periodically, as the vehicle travels the travel route.

The information on position and acceleration may be acquired at the same time. The information on position and acceleration does not have to be acquired at the same time as long as correspondence between them can be established. For example, if the information on position and acceleration is associated with time information at which they were acquired, the position at the time the acceleration was acquired can be calculated by interpolation from the position information before and after the time the acceleration was acquired.

The second travel data is data that accumulates information on position and acceleration obtained when vehicles equipped with each of a plurality of tires in which a predetermined failure has not occurred traveled the travel route in the past. Hereinafter, a tire in which a predetermined failure has not occurred is referred to as a second tire. A tire in which a predetermined failure has not occurred is a tire that did not experience a predetermined failure during its period of use. For example, a tire that was used until the tread surface wore down and the tread wear indicator appeared on the tread surface is a tire in which a predetermined failure has not occurred.

The first travel data and second travel data acquired by the communication interface 11 are stored in the storage 13 by the controller 12. Note that the risk evaluation apparatus 10 may read the first travel data and second travel data from a storage medium instead of via the communication interface 11. The storage medium includes, for example, a USB (Universal Serial Bus) memory, CD (Compact Disc), and DVD (Digital Versatile Disc).

The controller 12 includes one or more processors. The processor may be a general-purpose processor such as a CPU (Central Processing Unit) that executes a program defining control procedures, or a dedicated processor specialized for specific processing. The controller 12 performs arithmetic processing for executing each function of the risk evaluation apparatus 10 and controls each component of the risk evaluation apparatus 10.

The storage 13 includes one or more memories. The memory may be, for example, a semiconductor memory, magnetic memory, or optical memory, but is not limited thereto and may be any memory. The semiconductor memory may include volatile memory such as RAM (Random Access Memory), and non-volatile memory such as ROM (Read Only Memory) and flash memory. The magnetic memory may include, for example, a hard disk and magnetic tape. The optical memory may include, for example, a CD (Compact Disc), DVD (Digital Versatile Disc), and BD (Blu-ray Disc).

The storage 13 stores information used in processing performed by the controller 12, and information generated as a result of processing by the controller 12. The storage 13 stores the first travel data and second travel data. The storage 13 stores map information including the travel route traveled by the vehicle. The map information may include information such as latitude, longitude, and elevation of each position on the travel route. The storage 13 may further store programs executed by the controller 12.

### Terminal Device

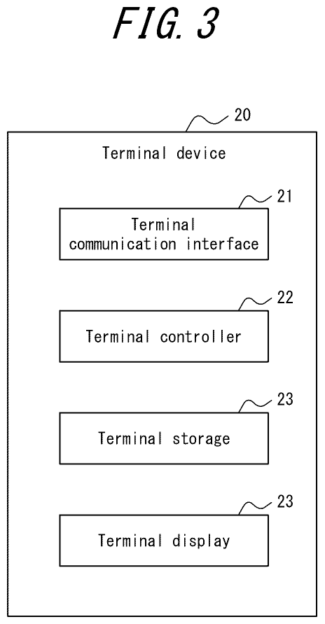

The terminal device 20 includes a computer such as a PC and a portable information terminal such as a smartphone. The terminal device 20 may be installed at the business office of an operator operating the vehicle and/or inside a currently operating vehicle. As illustrated in FIG. 3, the terminal device 20 includes a terminal communication interface 21, a terminal controller 22, a terminal storage 23, and a terminal display 24.

The terminal communication interface 21 provides a communication function with other devices including the risk evaluation apparatus 10. The terminal communication interface 21 includes a communication module that connects to a communication network such as the Internet, similar to the communication interface 11 of the risk evaluation apparatus 10.

The terminal controller 22 includes one or more processors, similar to the controller 12 of the risk evaluation apparatus 10. The terminal controller 22 receives notifications from the risk evaluation apparatus 10 via the terminal communication interface 21 and causes the terminal display 24 to display their content.

The terminal storage 23 includes one or more memories, similar to the storage 13 of the risk evaluation apparatus 10. The terminal storage 23 may store information used in processing by the terminal controller 22, such as map information of the travel route.

The terminal display 24 is a display for presenting various information. The terminal display 24 may include, for example, a liquid crystal display and an organic EL (Electro Luminescence) display, but is not limited thereto. The terminal display 24 can present notifications received from the risk evaluation apparatus 10 by text display or graphical display using a GUI (Graphical User Interface).

### Processing Performed by the Controller of the Risk Evaluation Apparatus

The controller 12 of the risk evaluation apparatus 10 evaluates the risk of tire failure occurrence on the travel route based on the difference in acceleration included in the first travel data and the second travel data stored in the storage 13. The difference in acceleration corresponds to the input of force to the tire, that is, the difference in force applied to the tire. A large acceleration means that a large force, which can cause failure, was applied to the tire.

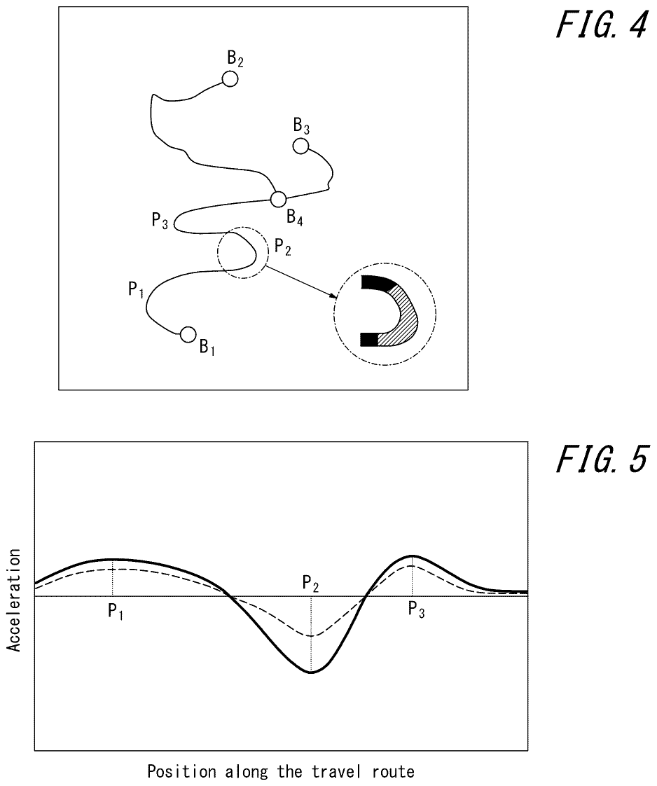

For example, a travel route as illustrated in FIG. 4 is assumed. FIG. 4 is a map illustrating a travel route for a mine vehicle, for example. The vehicle reciprocates between base B₁ and base B₂, and between base B₁ and base B₃. For example, base B₁ is located at the foot of a mountain, and bases B₂ and B₃ are located at the upper part of the mountain. Base B₄ is a branch point between the travel route from base B₁ to base B₂ and the travel route from base B₁ to base B₃.

In one embodiment, the controller 12 compares the acceleration obtained from the first travel data and the acceleration obtained from the second travel data on the travel route. The values of each acceleration may be values obtained by statistically processing a plurality of first travel data and a plurality of second travel data for each position on the travel route. The statistical processing includes, for example, processing for calculating an average value, processing for calculating a median value, and processing for generating a frequency distribution and extracting the interval of acceleration with the highest frequency, among others.

FIG. 5 is a diagram comparing, at each position along the travel route between base B₁ and B₄, the acceleration obtained from the first travel data (solid line) and the acceleration obtained from the second travel data (dashed line). FIG. 5 is a diagram prepared for explanation and is not an actual diagram. FIG. 5, for example, indicates acceleration in the lateral direction. The controller 12 may compare not only acceleration in one axis direction but also acceleration in two or three axes. When the controller 12 calculates acceleration in three axes, it can handle acceleration including longitudinal, lateral, and up-down directions, making it possible to evaluate the risk of tire failure occurrence by considering braking, curves in the travel route, and variations in gradient.

The controller 12 quantifies the difference between the acceleration in the first travel data and the acceleration in the second travel data. For example, the controller 12 may calculate and compare the magnitude of acceleration for three-axis acceleration including three-dimensional directional components. The controller 12 may identify positions where the difference in acceleration is relatively large compared to the surroundings as risk locations P₁, P₂, and P₃. By doing so, risk locations can be easily identified on the travel route. The risk locations P₁, P₂, and P₃ are, for example, locations where the travel route curves (bends), as illustrated in FIG. 4. In setting the risk locations P₁, P₂, and P₃, the controller 12 may set the risk locations in consideration of the shape of the travel route based on the map information of the travel route stored in the storage 13. For example, locations where the curve of the travel route is sharp (where the radius of curvature is small) and locations where the variation in road surface gradient is significant may be preferentially set as risk locations. By doing so, since risk locations can be identified in consideration of the shape of the travel route specified from the map information, the accuracy of identifying risk locations is improved.

Furthermore, the controller 12 may rank the plurality of risk locations P₁, P₂, and P₃ based on the magnitude of the difference in acceleration. For example, in the example of FIG. 5, the difference in acceleration at risk location P₂ is greater than at risk locations P₁ and P₃. Therefore, the controller 12 can determine that risk location P₂ has the highest risk of tire failure occurrence. By doing so, the risk evaluation apparatus 10 can easily identify and address locations with a high risk of tire failure occurrence on the travel route.

The controller 12 may extract only a predetermined number of risk locations from all travel routes. The predetermined number is set to a number that the user of the risk evaluation apparatus 10 can easily grasp and address. The predetermined number may be, for example, 3, 5, or 10. By doing so, the user of the risk evaluation apparatus 10 can focus on addressing only the predetermined number of risk locations with a high risk of tire failure occurrence.

The controller 12 transmits information including the extracted predetermined number of risk locations P₂ to the terminal device 20 via the communication interface 11.

In the terminal device 20, when information on the predetermined number of risk locations P₂ is received via the terminal communication interface 21, the terminal controller 22 may cause the terminal display 24 to present the risk locations P₂ on the travel route. The risk locations P₂ on the travel route may be presented, as partially enlarged in FIG. 4, by changing the display mode, such as coloring the corresponding location on the travel route in a different color such as red, or making it blink. In FIG. 4, only one risk location P₂ is presented, but in practice, all of the predetermined number of risk locations on the travel route may be presented on the same screen.

The controller 12 of the risk evaluation apparatus 10 may further determine measures for suppressing the predetermined failure at the risk locations based on the acceleration information and map information of the travel route. For example, methods for suppressing the predetermined failure include limiting speed before the risk location and providing signs to prompt braking operations. For example, if there is a straight route before the risk location and a large acceleration in the longitudinal direction is applied at the risk location, it is considered that the vehicle is making a sudden brake. Therefore, the controller 12 may determine a measure to provide a sign to prompt braking operation before the risk location. As another example of a method for suppressing the predetermined failure, an alternative route to avoid the risk location may be proposed. The risk evaluation apparatus 10 may be configured to have, in advance, multiple measures for suppressing the predetermined failure, and to appropriately select one of the measures based on the magnitude and direction of acceleration and the pattern of the travel route shape. The risk evaluation apparatus 10 may be configured to newly generate a measure from a pattern of pre-prepared measures. Furthermore, the risk evaluation apparatus 10 may present options for multiple measures for suppressing the predetermined failure, allowing the user to select a preferred one from among them. By adopting such a presentation method, it becomes possible to respond more in line with the user's needs.

The controller 12 causes the determined measure or options for multiple measures to be transmitted to the terminal device 20 via the communication interface 11. The terminal display 24 of the terminal device 20 presents the received measure to the user. As a result, the user can easily determine a method for addressing the risk of tire failure occurrence on the travel route.

### Risk Evaluation Method

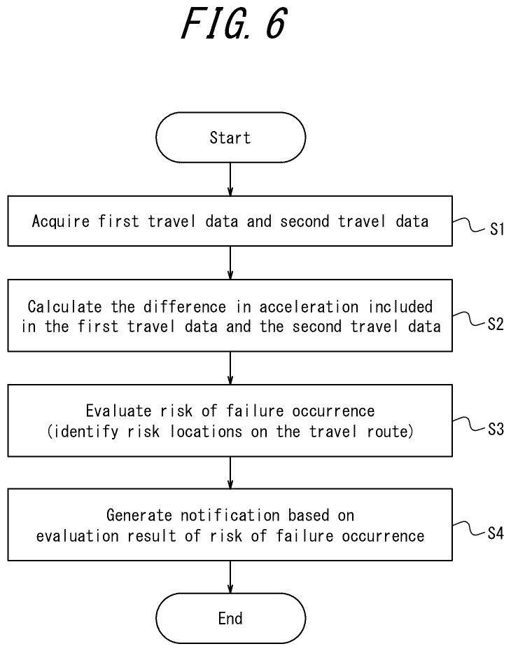

With reference to FIG. 6, the procedure of the method for evaluating the risk of tire failure occurrence executed by the risk evaluation apparatus 10 will be described.

First, the risk evaluation apparatus 10 acquires first travel data related to vehicles in which a predetermined failure occurred and second travel data related to vehicles in which a predetermined failure has not occurred (step S1). The first travel data and the second travel data are stored in the storage 13.

The controller 12 calculates the difference in acceleration at each position included in the first travel data and the second travel data (step S2). The controller 12 can analyze the magnitude and direction of the force applied to the tire based on the difference in acceleration.

The controller 12 evaluates the risk of tire failure occurrence based on the difference in acceleration (step S3). The controller 12 can identify, as risk locations, positions on the travel route where the acceleration in the first travel data is greater than that in the second travel data.

The controller 12 can generate a notification based on the result of the evaluation of the risk of tire failure occurrence and transmit it to the terminal device 20 via the communication interface 11 (step S4). The evaluation result of the risk of tire failure occurrence includes information on the risk locations. The risk locations may be a predetermined number of risk locations selected from those with a high risk of tire failure occurrence. In the terminal device 20, information on the evaluation result of the risk of tire failure occurrence is displayed on the terminal display 24. As a result, the user can recognize where on the travel route there is a high risk of tire failure occurrence.

As described above, according to the risk evaluation apparatus 10 of the present disclosure, it is possible to evaluate the risk of tire failure occurrence on a travel route by a simple method. In addition, by improving the driving of the vehicle at positions with a high risk of tire failure occurrence on the travel route based on the result of the risk evaluation, it is possible to prevent in advance usage that leads to early tire disposal and to suppress or delay the occurrence of a predetermined failure.

### Risk Evaluation System

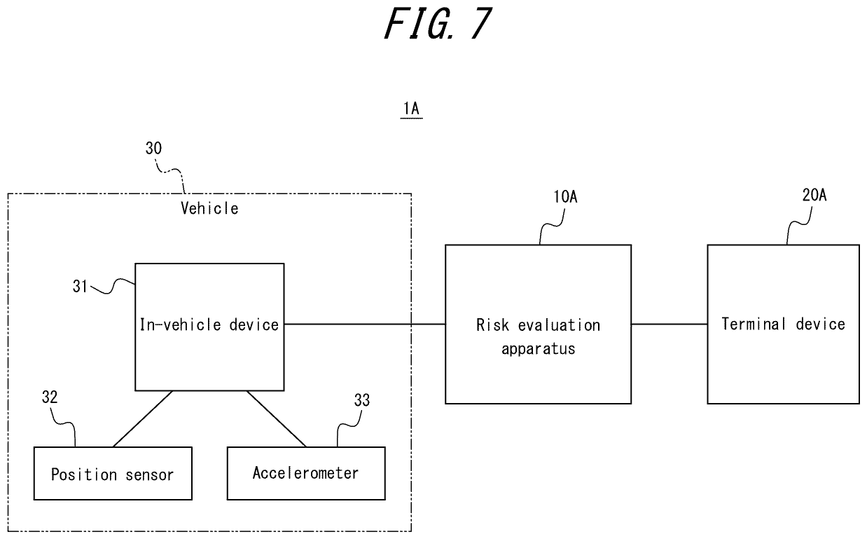

Another embodiment of the present disclosure, a risk evaluation system 1A, will be described with reference to FIG. 7. The risk evaluation system 1A includes a risk evaluation apparatus 10A, a terminal device 20A, and a plurality of vehicles 30 currently in operation. Each vehicle 30 includes an in-vehicle device 31, a position sensor 32 for detecting the position of the vehicle 30, and an accelerometer 33 for detecting the acceleration of the vehicle 30. The position sensor 32 is a position detector. The accelerometer 33 is an acceleration detector.

The risk evaluation apparatus 10A can be a server computer, workstation, or a computer such as a PC. The risk evaluation apparatus 10A has the same components as the risk evaluation apparatus 10 illustrated in FIG. 2. The components of the risk evaluation apparatus 10A will be described using the same names and reference numerals as those of the risk evaluation apparatus 10. The risk evaluation apparatus 10A differs from the risk evaluation apparatus 10 illustrated in FIG. 2 in the processing content of the controller 12 and the information stored in the storage 13.

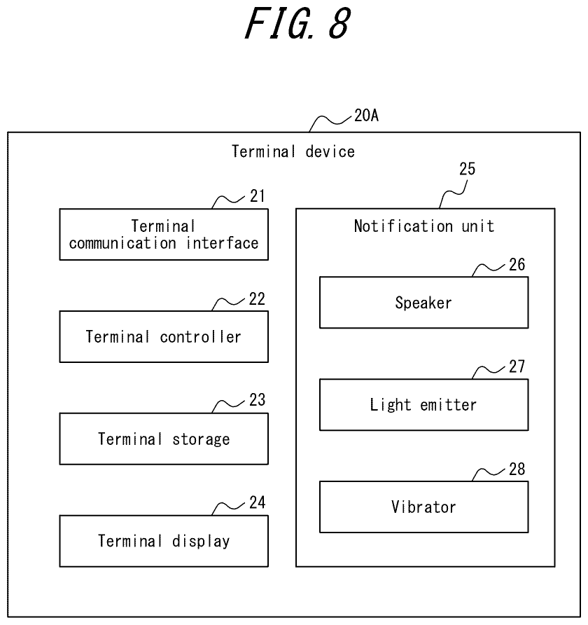

The terminal device 20A is a portable information terminal such as a smartphone. The terminal device 20A may be a terminal carried by the driver of the vehicle 30. As illustrated in FIG. 8, the terminal device 20A includes, in addition to the components of the terminal device 20 illustrated in FIG. 3, a notification unit 25. The notification unit 25 can notify a user who is not visually checking the terminal display 24 of a notification. The notification unit 25 may include at least one of a speaker 26, a light emitter 27 such as an LED (Light Emitting Diode), and a vibrator 28 such as a vibration motor. The notification unit 25 can notify by any one or more of text, sound, light, and vibration.

The in-vehicle device 31 is an electronic device mounted on the vehicle. While the vehicle is traveling along the travel route, the in-vehicle device 31 can acquire, periodically or non-periodically, position information detected by the position sensor 32 and acceleration information detected by the accelerometer 33, and transmit them to the risk evaluation apparatus 10A. The information on the position and acceleration of the vehicle 30 is referred to as third travel data. The communication interface 11 of the risk evaluation apparatus 10A functions as an acquisition unit for acquiring the third travel data.

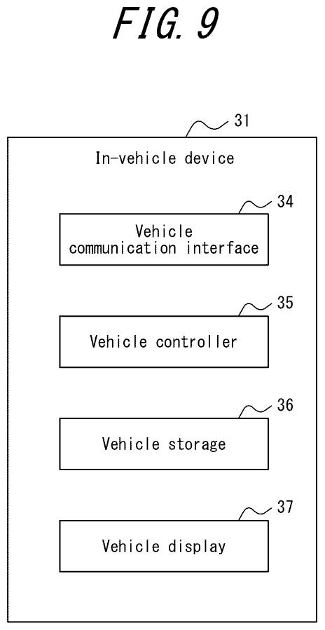

As illustrated in FIG. 9, the in-vehicle device 31 includes a vehicle communication interface 34 and a vehicle controller 35. The in-vehicle device 31 may further include a vehicle storage 36 and a vehicle display 37.

The vehicle communication interface 34 acquires position information and acceleration information from the position sensor 32 and the accelerometer 33. The vehicle communication interface 34 may be connected to the position sensor 32 and the accelerometer 33 by wired or wireless communication. In addition, similar to the communication interface 11 of the risk evaluation apparatus 10 and the terminal communication interface 21 of the terminal device 20, the vehicle communication interface 34 provides a communication function for communicating with external devices of the in-vehicle device 31.

The vehicle controller 35, similar to the controller 12 of the risk evaluation apparatus 10 and the terminal controller 22 of the terminal device 20, includes one or more processors. The vehicle controller 35 transmits the position information and acceleration information to the risk evaluation apparatus 10 via the vehicle communication interface 34. The vehicle controller 35 also controls each component of the in-vehicle device 31.

The vehicle storage 36, similar to the storage 13 of the risk evaluation apparatus 10 and the terminal storage 23 of the terminal device 20, includes one or more memories. The vehicle storage 36 may store and accumulate the third travel data acquired from the position sensor 32 and the accelerometer 33.

The vehicle display 37 is a display that displays various information under the control of the vehicle controller 35. The vehicle display 37 can use a display provided in the center cluster or the like of the vehicle. The in-vehicle device 31 may provide some of the functions of the terminal device 20A in place of the terminal device 20A. For example, the risk evaluation apparatus 10A may transmit a notification, which is displayed as text or graphics regarding the evaluation result of the risk of tire failure occurrence, to the in-vehicle device 31, and the vehicle display 37 may display this notification. Even in this case, alerts to the user may be notified to the user by the notification unit 25 of the terminal device 20A.

The controller 12 of the risk evaluation apparatus 10A sequentially stores the third travel data of the vehicle 30 received from the in-vehicle device 31 in the storage 13. The storage 13 may store and accumulate not only the third travel data obtained when the vehicle 30 is currently traveling the travel route, but also the position and acceleration data when the travel route was traveled multiple times in the past.

The controller 12 of the risk evaluation apparatus 10A evaluates the similarity of the acceleration data with respect to position by comparing the third travel data of the vehicle 30 received from the in-vehicle device 31 with the first travel data and/or the second travel data. For comparison, the first travel data, the second travel data, and the third travel data may use statistically processed data of acceleration with respect to position. The statistical processing is, for example, averaging processing.

The similarity between the first travel data and the second travel data and the third travel data can be evaluated by any known method. For example, the similarity can be evaluated by the absolute value of the difference in acceleration with respect to position along the travel route, or by a value obtained by integrating the square of the difference in acceleration along the travel route. The smaller these values are, the higher the similarity can be evaluated. Similarly, the similarity of the travel data can be evaluated using the average value of the absolute value of the difference in acceleration at a finite number of positions, or the root mean square value of the absolute value of the difference in acceleration.

A high similarity between the third travel data and the first travel data means that the travel pattern of the vehicle 30 in use is close to the travel pattern of a vehicle in which a predetermined failure occurred. Therefore, in this case, the controller 12 can generate a notification including alert information and transmit this notification to the terminal device 20A. For example, the controller 12 may transmit such a notification when the third travel data is more similar to the first travel data than to the second travel data. The notification may be transmitted to the user of the risk evaluation system 1A by email and/or SMS (Short Message Service).

The notification includes an instruction to reduce speed at positions identified as risk locations. The controller 12 may transmit a notification when the vehicle 30 is approaching a specific risk location based on the position information acquired from the vehicle 30. The terminal device 20A displays the notification content on the terminal display 24 and notifies the user of the terminal device 20A that the notification has been received by the notification unit 25. In this way, the risk evaluation apparatus 10 can alert the vehicle 30 in operation to avoid a travel method that is likely to cause a predetermined failure.

The controller 12 may determine a method for driving the vehicle 30 so that the third travel data becomes more similar to the second travel data. For example, if the acceleration in the third travel data is higher than that in the second travel data at a predetermined position, the controller 12 determines to decelerate the vehicle 30 before that position. The controller 12 generates a notification in accordance with this determination and transmits this notification to the terminal device 20A. Upon receiving this notification, the terminal device 20A displays the notification content on the terminal display 24 and notifies the user of the terminal device 20A that the notification has been received by the notification unit 25. In this way, the risk evaluation apparatus 10 can improve the travel method of the vehicle 30 in operation so as to make it less likely for a predetermined failure to occur. In addition, since the notification unit 25 can notify by any one or more of sound, light, and vibration, it is possible to generate a notification for avoiding and/or delaying a predetermined failure in an appropriate manner according to the user's usage environment.

In the risk evaluation system 1A illustrated in FIG. 7, the third travel data stored in the storage 13 of the risk evaluation apparatus 10A may ultimately be added to the first travel data or the second travel data and used to update these travel data. For example, if a predetermined failure occurs in the tire of the vehicle 30 and the tire is replaced, the third travel data of the vehicle 30 that traveled with that tire mounted can be added to the first travel data. If a predetermined failure does not occur in the tire of the vehicle 30 and the tire can be used until the end of its service life, the third travel data of the vehicle 30 that traveled with that tire mounted can be added to the second travel data. The process of adding the third travel data to the first travel data or the second travel data may be performed by a human when replacing the tire of the vehicle 30. Alternatively, an algorithm for determining that the tire of the vehicle 30 has failed and/or that the tire has been replaced may be installed in the controller 12 of the risk evaluation apparatus 10A, and the risk evaluation apparatus 10A may perform such processing automatically. In this way, the risk evaluation apparatus 10A can improve the accuracy of the evaluation of the risk of tire failure occurrence by sequentially updating the first travel data and the second travel data.

The embodiments of the present disclosure have been described above with reference to the drawings and examples, but it should be noted that those skilled in the art can easily make various modifications or alterations based on the present disclosure. Therefore, it should be noted that such modifications or alterations are included within the scope of the present disclosure. For example, the functions included in each component or each step can be rearranged as long as they are not logically inconsistent, and a plurality of components or steps can be combined into one or divided.

The embodiments of the present disclosure have been described mainly with respect to apparatuses, but the embodiments of the present disclosure can also be realized as methods including steps executed by each component of the apparatus. The embodiments of the present disclosure can also be realized as methods executed by a processor provided in the apparatus, as programs, or as storage media recording such programs. It should be understood that these are also included within the scope of the present disclosure.

### Contribution to the Sustainable Development Goals (SDGs) led by the United Nations

The SDGs have been advocated for the realization of a sustainable society. One embodiment of the present disclosure is considered to be a technology that can contribute to, for example, “No. 12_Responsible Consumption and Production” and “No. 13_Climate Action.”

### REFERENCE SIGNS LIST

1, 1A Risk evaluation system
10 Risk evaluation apparatus
11 Communication interface (acquisition unit)
12 Controller
13 Storage
20, 20A Terminal device
21 Terminal communication interface
22 Terminal controller
23 Vehicle storage
24 Vehicle display
25 Notification unit
26 Speaker
27 Light emitter
28 Vibrator
30 Vehicle
31 In-vehicle device
32 Position sensor (position detector)
33 Accelerometer (acceleration detector)
34 Vehicle communication interface
35 Vehicle controller
36 Vehicle storage
37 Vehicle display
P₁~P₃ Risk location
B₁~B₄ Base

1. A risk evaluation apparatus comprising:
a storage configured to store first travel data for a plurality of first tires in which a predetermined failure occurred, the first travel data accumulating information on position and acceleration when a vehicle, on which each of the first tires was mounted, traveled a travel route in the past, and second travel data for a plurality of second tires in which the predetermined failure has not occurred, the second travel data accumulating information on position and acceleration when a vehicle, on which each of the second tires was mounted, traveled the travel route in the past; and
a controller configured to evaluate a risk of tire failure occurrence on the travel route based on a difference between the acceleration included in the first travel data and the acceleration included in the second travel data.

2. The risk evaluation apparatus according to claim 1, wherein the controller quantifies the difference between the acceleration in the first travel data and the acceleration in the second travel data, and identifies, from the travel route, positions at which the quantified difference in acceleration is relatively large as risk locations.

3. The risk evaluation apparatus according to claim 2, wherein the controller ranks the risk locations based on a magnitude of the difference in the acceleration.

4. The risk evaluation apparatus according to claim 3, wherein the controller extracts only a predetermined number of the risk locations in order from a largest difference in the acceleration among the risk locations subjected to ranking.

5. The risk evaluation apparatus according to claim 2, wherein the controller identifies the risk locations on the travel route based on map information of the travel route.

6. The risk evaluation apparatus according to claim 2, wherein the controller generates, selects, or determines one or more measures for suppressing the predetermined failure at the risk locations based on the difference in the acceleration.

7. The risk evaluation apparatus according to claim 1, wherein the first tires and the second tires are at least any of tires of a port vehicle, a bus or truck that repeatedly travels a specific route, and a mine vehicle.

8. The risk evaluation apparatus according to claim 1, wherein the acceleration includes three-dimensional directional components.

9. A risk evaluation method to be executed by a computer, comprising:
acquiring first travel data for a plurality of first tires in which a predetermined failure occurred, the first travel data accumulating information on position and acceleration when a vehicle, on which each of the first tires was mounted, traveled a travel route in the past, and second travel data for a plurality of second tires in which the predetermined failure has not occurred, the second travel data accumulating information on position and acceleration when a vehicle, on which each of the second tires was mounted, traveled the travel route in the past; and
evaluating a risk of tire failure occurrence on the travel route based on a difference between the acceleration included in the first travel data and the acceleration included in the second travel data.

10. A risk evaluation system comprising:
a vehicle having a position detector configured to detect position, an accelerometer configured to detect acceleration, and a vehicle communication interface configured to transmit information on the position and the acceleration to the risk evaluation apparatus;
the risk evaluation apparatus according to claim 1; and
a terminal device configured to report a notification transmitted from the risk evaluation apparatus,
wherein the controller of the risk evaluation apparatus generates the notification based on the evaluation of the risk of failure occurrence and transmits the notification to the terminal device for reporting.

11. The risk evaluation system according to claim 10, wherein the risk evaluation apparatus includes an acquisition interface configured to acquire, as third travel data, information on position and acceleration when the vehicle has traveled the travel route, and the controller generates the notification based on similarity between the third travel data and the first travel data and transmits the notification to the terminal device.

12. The risk evaluation system according to claim 10, wherein the risk evaluation apparatus includes an acquisition unit configured to acquire, as third travel data, information on position and acceleration when the vehicle has traveled the travel route, and the controller generates a notification including a method for increasing similarity between the third travel data and the second travel data and transmits the notification to the terminal device.

13. The risk evaluation system according to claim 10, wherein the storage accumulates the information on the position and the acceleration acquired from the vehicle, and the controller updates the first travel data or the second travel data using the accumulated information on the position and the acceleration.

14. The risk evaluation system according to claim 10, wherein the terminal device includes at least one of a display, a speaker, a light emitter, and a vibrator, and reports the notification by at least one of text, sound, light, and vibration.

15. The risk evaluation apparatus according to claim 2, wherein the first tires and the second tires are at least any of tires of a port vehicle, a bus or truck that repeatedly travels a specific route, and a mine vehicle.

16. The risk evaluation apparatus according to claim 2, wherein the acceleration includes three-dimensional directional components.

17. The risk evaluation apparatus according to claim 3, wherein the controller identifies the risk locations on the travel route based on map information of the travel route.

18. The risk evaluation apparatus according to claim 3, wherein the controller generates, selects, or determines one or more measures for suppressing the predetermined failure at the risk locations based on the difference in the acceleration.

19. The risk evaluation apparatus according to claim 3, wherein the first tires and the second tires are at least any of tires of a port vehicle, a bus or truck that repeatedly travels a specific route, and a mine vehicle.

20. The risk evaluation apparatus according to claim 3, wherein the acceleration includes three-dimensional directional components.
